(19) United States
(12) Patent Application Publication
(10) Pub. No.: US 2015/0377068 A1
(43) Pub. Date: Dec. 31, 2015

(54) COMPONENT ARRANGEMENT FOR A GAS TURBINE

(71) Applicant: MTU Aero Engines AG, Munich (DE)

(72) Inventors: Alois Eichinger, Pfaffenhofen (DE); Stefan Sasse, Petershausen (DE); Mark Fritz, Dachau (DE)

(21) Appl. No.: 14/730,801

(22) Filed: Jun. 4, 2015

(30) Foreign Application Priority Data
Jun. 6, 2014 (EP) 14 171 509.4

(51) Int. Cl. F01D 25/28; B23P 19/04; F23R 3/00

(52) U.S. Cl. CPC F01D 25/28; F23R 3/002; B23P 19/04

(57) ABSTRACT

The present invention relates to a component arrangement for a gas turbine, having a first component of a gas turbine duct casing; a second component, connected to it, of a gas turbine duct casing with a flange; a rocker with an articulated section, which is rotatably mounted in a groove on the first component, which, in a cross section perpendicular to the groove longitudinal direction, has two groove flanks that lie opposite each other in the groove width direction, a groove base connecting these groove flanks, and a groove edge that lies opposite the groove base in a groove depth direction; and a setting screw. The flange of the second component is clamped between the first component and an arm of the rocker, which is tightened against the flange by the setting screw.

The present invention relates to a component arrangement for a gas turbine, having a first and a second component, a method for connecting the first and second component of such a component arrangement for a gas turbine, and a gas turbine, in particular an aircraft engine, having such a component arrangement for a gas turbine.

In gas turbines, a large number of components must be connected to one another. Thus, according to hitherto internal company practice, for example, so-called fairings and panels of a turbine center frame (TCF) are connected to one another in such a way that threaded bolts, on which clamping plates are tightened, are welded into the fairings. The present invention can be used for such fairings and panels, in particular, and is therefore illustrated below as such by way of example, although it can equally be used for connecting other components of a gas turbine.

An object of an embodiment of the present invention is therefore to provide a gas turbine having at least two components that are connected to one another.

This object is achieved by a component arrangement for a gas turbine having the features of claim 1. Claims 13, 14 afford patent protection to a method for connecting a first and a second component of such a component arrangement for a gas turbine, as well as a gas turbine, in particular an aircraft engine, having such a component arrangement for a gas turbine. Advantageous embodiments of the invention are the subject of the dependent claims.

According to an aspect of the present invention, a component arrangement for a gas turbine has a first component and a second component that is connected to it.

In particular, the first component can be a first wall segment, in particular a so-called fairing or panel, of a gas turbine duct casing, in particular a turbine center frame between a first turbine and a second turbine, the second component corresponding, in particular, to a second wall segment, in particular a panel or fairing, of the gas turbine duct casing.

The second component has a flange, which partially overlaps a top surface of the first component, which will be referred to below, without any limitation of generality, as a top side of the first component. A surface of the first component lying opposite to this top side is correspondingly referred to below, without any limitation of generality, as a bottom side of the first component. In particular, the top side can be a radial outer surface of the first component and the bottom side correspondingly, in particular, a radial inner surface. Additionally or alternatively, the top side can be a surface facing away from a gas duct defined by the component, and the bottom side correspondingly can be a surface facing a gas duct defined by the component, in particular the surface defining the gas duct.

The flange of the second component is beveled in one embodiment so as to partially overlap partially the first component. Additionally or alternatively, an edge of the first component that is overlapped by the flange can also be beveled.

The component arrangement for a gas turbine has a rocker with an articulated section and at least one arm, which is also referred to below as the first arm for purposes of differentiation. In one embodiment, the rocker has another arm on a side of the articulated section that lies opposite the first arm, said other arm being referred to correspondingly as the second arm. In one embodiment, the articulated section and the arm or arms are constructed integrally with each other.

In particular, the articulated section is mounted rotatably around an axis of rotation in a groove on the first component. For this purpose, the articulated section has a rounded, in particular at least partially cylindrically shaped, contour or shell surface in one embodiment. In an enhancement, a cross section of the articulated section has a circular segment-shaped outer contour of at least 30°.

In a cross section perpendicular to a direction that is referred to below as the groove longitudinal direction, the groove has two groove flanks, which lie opposite each other in a direction that will be referred to below as a groove width direction and, in one embodiment, is perpendicular to the groove longitudinal direction. The groove flanks are connected by a groove base, which lies opposite an open groove edge, with the direction from the groove base to the groove edge being referred to below as the groove depth direction, which, in one embodiment, is perpendicular to the groove longitudinal direction and/or groove width direction.

In one embodiment, the groove extends, at least essentially, in the axial direction of the gas turbine and is parallel to the center axis or rotor axis thereof. Correspondingly, the groove longitudinal direction can be parallel to the axial direction of the gas turbine. In another embodiment, the groove extends, at least essentially, in the peripheral direction of the gas turbine or perpendicular to the center axis or rotor axis thereof. Correspondingly, the groove longitudinal direction can be parallel to the peripheral direction of the gas turbine.

In one embodiment, an extension, in particular a maximum extension, of the groove in the groove longitudinal direction is at least two times, in particular at least four times, an extension of the groove, in particular a maximum extension thereof, in the groove width direction.

In one embodiment, the groove has, at least essentially, a rectangular cross section. This is advantageously simple to fabricate. In another embodiment, a groove cross section converges in the groove depth direction toward the groove edge or the groove flanks exhibit an undercut, in particular a radius, toward the groove edge. In this way, in one embodiment, it is possible in a form-fitting manner to prevent the articulated section from being pulled out of the groove in the groove depth direction. Generally, in one embodiment, the articulated section mounted in the groove has a maximum dimension in the groove width direction that is greater that the separation of the two groove flanks at the groove edge, so as to prevent in a form-fitting manner the articulated section from being pulled out of the groove. In one embodiment, the groove has, at least essentially, a circularly shaped cross section; in particular, one or both of the groove flanks and/or the groove base can have a radius, preferably the same radius. In this way, it is possible to improve the rotatable mounting of the articulated section, the contour or shell surface of which preferably has radii corresponding to the groove flanks.

In one embodiment, an axis of rotation, around which the articulated section is rotatable (rotatably mounted) in the groove, is parallel to and, in particular, in alignment with the groove longitudinal direction.

The component arrangement for a gas turbine has a setting screw with an outer thread or an inner thread and a screw axis or a longitudinal axis.

According to an aspect of the present invention, the flange of the second component will be or is clamped between the first component and the (first) arm of the rocker, which will be or is tightened or pressed against the flange by the setting screw. In this way, the first and the second components can be connected to each other in an advantageous way by friction fit, in particular in a detachable manner. By adjusting or altering the tension of the setting screw, it is possible advantageously to adjust or alter the friction fit.

In one embodiment, the setting screw is supported on the first component on a rocker-side or rocker-facing surface or on the top side of the first component, which is partially overlapped by the flange of the second component, or lies on top of it. In this way, in one embodiment, the setting screw can advantageously be screwed from the top side and thus the connection (dis)assembled or adjusted. In particular, when the bottom side lying opposite the top side defines a gas duct, it is thereby possible to prevent any interference with the gas duct by the setting screw and/or to simplify the dis(assembly). Correspondingly, in one embodiment, the setting screw is supported on a surface of the first component, in particular the top side thereof, that is closed at least in the region of the support, or lies on top of this closed surface or side.

In one embodiment, the setting screw will be or is arranged on a side of an axis of rotation, lying opposite the (first) arm, of the articulated section that is rotatably mounted in the groove and/or forces apart the first component and the rocker, in particular a second arm of the rocker, which is arranged on the side of the axis of rotation of the articulated section that lies opposite the first arm. In this way, in one embodiment, it is possible to exploit an advantageous cantilever action. Additionally or alternatively, the setting screw is thus advantageously placed under pressure.

In one embodiment, the articulated section that is rotatably mounted in the groove is secured in a form-fitting manner and, in particular, fixed in position in at least one direction from the top side of the first component, in particular in a direction parallel to the screw axis of the setting screw and/or parallel to the clamping direction of the clamping between flange and (first) arm of the rocker away from the top side of the first component. In particular, to this end, the groove has, in one embodiment, an undercut or a stop in this direction, at which the articulated section is supported against any movement from the top side of the first component. In this way, the articulated section, which is rotatably mounted in the groove, functions as a rotating bearing or thrust bearing. When the rocker is supported radially outward on the first component, the articulated section is supported correspondingly in the groove in a form-fitting manner against any radial outward movement in one embodiment.

In one embodiment, the setting screw will be or is secured in a form-fitting manner in the groove longitudinal direction in a recess in the first component, in particular the top side thereof. For this purpose, the tightened setting screw engages in the recess, which, in an enhancement, is designed as a blind hole.

In one embodiment, the setting screw will be or is screwed with a thread in the rocker, in particular the second arm thereof, in order to tighten or press the (first) arm thereof against the flange. In this way, in an enhancement, it is possible advantageously to dispense with an additional nut. In another embodiment, the setting screw is or will be screwed together with a nut, which, in turn, is supported on the rocker, in particular the second arm thereof, in order to tighten or press the (first) arm thereof against the flange. In this way, in an enhancement, it is possible advantageously to dispense with a thread in the rocker.

In one embodiment, the rocker is or will be secured in the groove longitudinal direction on one side or on both sides on the first component, in particular in a form-fitting manner. Securing is understood in the present case to mean, in particular, a form-fitting limitation of any movement of the rocker in the longitudinal direction of the groove.

Such a limitation can be realized, in particular, by a closed front end of the groove in the groove longitudinal direction. Correspondingly, in one embodiment, the groove is open at one end in the groove longitudinal direction and closed at the opposite-lying end, in particular so as to insert and withdraw the articulated section into and out of the groove by the open front end and, on the other hand, to restrict or limit, by means of the closed front end, any movement in the groove longitudinal direction. In another embodiment, the groove is open at both ends in the groove longitudinal direction, in particular so as to insert and withdraw the articulated section from the groove at will, by means of the one or the other open end. In another embodiment, the groove is closed at both ends in the groove longitudinal direction, in particular so as to restrict or limit by means of the closed ends, any movement of the articulated section in the groove longitudinal direction.

In particular, additionally or alternatively to a groove that is closed at one end or at both ends, the rocker can be or is secured on the first component in the groove longitudinal direction in a form-fitting manner at one end or at both ends, in that the rocker has a stop or two opposite-lying stops in the groove longitudinal direction, which engage(s) under the groove in a form-fitting manner.

In one embodiment, an angle between the groove depth direction and a clamping direction of the clamping of the flange between the first component and the first arm of the rocker and/or the radial direction of the gas turbine is at most 15°, in particular at most 5°; in particular, the groove depth direction and the clamping direction can be, at least essentially, parallel or the groove depth direction can be, at least essentially, the radial direction of the gas turbine. In this way, in one embodiment, an advantageous power flow will be or is realized. In another embodiment, the angle between the groove depth direction and the clamping direction and/or the radial direction of the gas turbine is at least 45°, in particular at least 75°; in particular, the groove depth direction and the clamping direction can be, at least essentially, perpendicular to each other or the groove depth direction can be, at least essentially, the axial direction of the gas turbine or parallel to the circumferential direction of the gas turbine. In other words, the groove can be arranged laterally. In this way, in one embodiment, the articulated section can be or is advantageously supported or mounted.

A clamping direction is understood in the present case to mean, in particular, the direction of the clamping force between the flange and the first component and/or the (first) arm of the rocker and/or a straight line through the contact line of the flange and the first component and the contact line of the flange and the (first) arm of the rocker.

In one embodiment, an angle between the groove depth direction and the screw axis of the setting screw is at most 15°, in particular at most 5°; in particular, the groove depth direction and the screw axis can be at least essentially parallel. In this way, in one embodiment, an advantageous power flow can be or is realized. In another embodiment, the angle between the groove depth direction and the screw axis of the setting screw is at least 30°, in particular at least 45°. In this way, in one embodiment, a (dis)assembly can be or is improved and/or a design space can be or is reduced.

In one embodiment, the groove will be or is arranged in a protruding flange of the first component, in particular laterally.

According to an aspect of the present invention, in order to connect the first and the second components, the articulated section of the rocker is mounted in the groove on the first component and then the setting screw is screwed in, so as to tighten the (first) arm against the flange.

Additional advantageous enhancements of the present invention ensue from the dependent claims and the following description of preferred embodiments. Shown partially schematically for this purpose are:

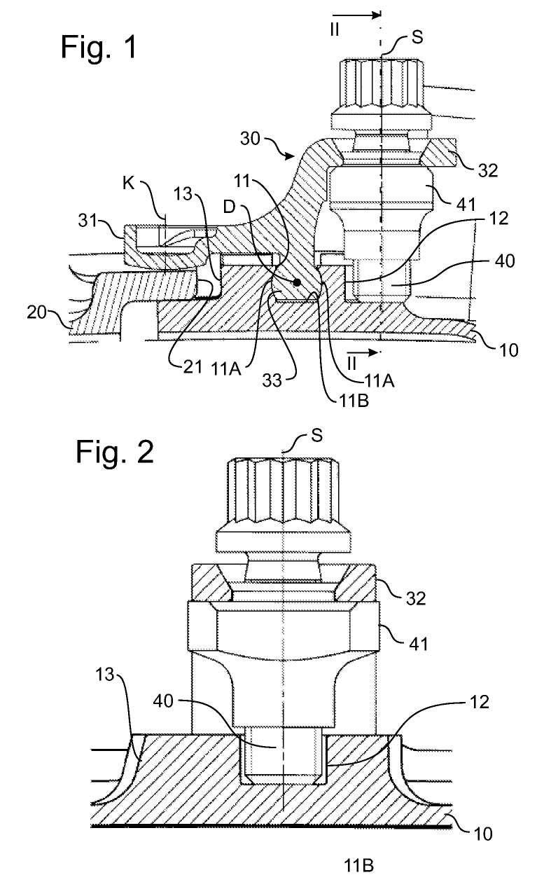

FIG. 1 a component arrangement for a gas turbine according to an embodiment of the present invention in a section perpendicular to the groove longitudinal direction and the axis of rotation of the gas turbine;

FIG. 2 a section along the line II-II in FIG. 1;

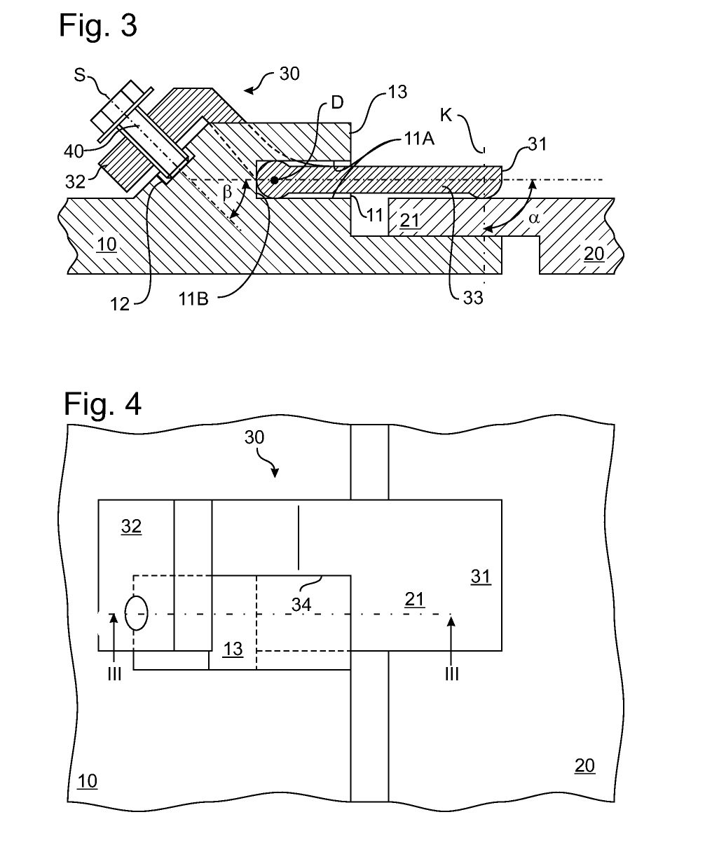

FIG. 3 a component arrangement for a gas turbine according to an embodiment of the present invention in an illustration corresponding to FIG. 1 along the line III-III in FIGS. 4; and

FIG. 4 a radially outward plan view of the component arrangement for a gas turbine of FIG. 3 without a setting screw.

FIG. 1 shows a component arrangement for a gas turbine according to an embodiment of the present invention in a section perpendicular to the groove longitudinal direction and the axis of rotation of the gas turbine, having a first component in the form of a fairing 10 of a TFC and a second component, connected to it, in the form of a panel 20 with a beveled flange 21, which overlaps the first component on its top side (above in FIGS. 1, 2). Equally, the first component 10 can also be a panel and the second component 20 a fairing. The top side is correspondingly a radial outer surface of the first fairing or panel that faces away from a gas duct defined by the components 10, 20.

The component arrangement for a gas turbine has a rocker 30 with an articulated section 33, a first arm 31, and a second arm 32 (right in FIG. 1), which is on a side of the articulated section lying opposite the first arm 31.

The articulated section 33 is rotatably mounted in a groove 11 on the first component. It has a partially cylindrically shaped contour or shell surface.

The groove 11 has two groove flanks 11A in the cross section of FIG. 1 perpendicular to the groove longitudinal direction, said groove flanks lying opposite each other in the groove width direction (horizontal in FIG. 1) and being connected by a groove base 11B, which lies opposite an open groove edge (top in FIG. 1) in the groove depth direction (vertical in FIG. 1).

The groove 11 extends in the axial direction of the gas turbine or parallel to the center axis or rotor axis thereof. In the cross section of FIG. 1, the two groove flanks 11A exhibit a radius. As a result, the groove cross section converges in the groove depth direction toward the groove edge and the groove flanks have an undercut toward the groove edge. The shell surface of the articulated section 33 mounted in the groove 11 exhibits radii corresponding to the groove flanks and thus a maximum dimension in the groove width direction that is greater than the separation of the two groove flanks at the groove edge, so as to prevent in a form-fitting manner the articulated section from being pulled out in the groove depth direction (upward in FIG. 1) from the groove. An axis of rotation D, around which the articulated section 33 is rotatable (rotatably mounted) in the groove 11 is in alignment with the groove longitudinal direction.

The component arrangement for a gas turbine has a setting screw 40 with an outer thread and a screw axis or longitudinal axis S.

The flange 21 of the second component 20 will be or is clamped between the first component 10 and the first arm 31 of the rocker 30, which will be or is tightened or pressed against the flange by the setting screw 40.

The setting screw 40 is supported on a closed surface or side of the first component 10 (top in FIG. 1) on the rocker side or facing the rocker 30 on the first component, said surface or side partially overlapping the flange of the second component.

The setting screw is arranged on a side (right in FIG. 1), lying opposite the first arm 31, of the axis of rotation D of the articulated section 33 rotatably mounted in the groove 11 and forces apart the first component 10 and the second arm 32 of the rocker.

As can be seen especially in FIG. 2, the tightened setting screw is secured in a form-fitting manner in the groove longitudinal direction (horizontal in FIG. 2) in a blind-hole-like recess 12 in the top side of the first component 10 and, for this purpose, engages in this recess.

The setting screw 40 is or will be screwed together with a nut 41, which, in turn, is supported on the second arm 32 of the rocker so as to tighten or press the first arm 31 thereof against the flange. The nut 41 is additionally supported on the rocker 30 in such a way that it is mounted secured against rotation, that is, cannot make any rotational movement relative to the rocker, when the setting screw 40 is screwed in.

The groove 11 is open at both ends in the groove longitudinal direction and is arranged in a radially protruding flange 13 of the first component.

The groove depth direction and a clamping direction K of the clamping of the flange between the first component and the first arm of the rocker are essentially parallel; the groove depth direction is essentially the radial direction of the gas turbine (vertical in FIG. 1). Correspondingly, the angle between the groove depth direction and the clamping direction is about 0°.

An angle between the groove depth direction and the screw axis S of the setting screw is likewise about 0°; that is, the groove depth direction and the screw axis are essentially parallel.

FIGS. 3, 4 show a component arrangement for a gas turbine according to an embodiment of the present invention in a plan view (FIG. 4) and a section along the line III-III, with the setting screw 40 not being depicted in the plan view of FIG. 4. Features corresponding to each other are identified by identical reference numbers, so that reference is made to the preceding description and only differences are addressed below.

In the embodiment of FIGS. 3, 4, the setting screw 40 is or will be screwed with a thread in the second arm 32 of the rocker 30 so as to tighten or press the first arm 31 thereof against the flange of the second component 20.

The rocker 30 is secured at one end in the groove longitudinal direction on the first component 10 in a form-fitting manner. For this purpose, a stop 34 of the rocker 30 engages under the groove 11 in the groove longitudinal direction in a form-fitting manner, as can be seen in the plan view of FIG. 4.

In the embodiment of FIGS. 3, 4, the angle a between the groove depth direction (horizontal in FIG. 3) and the clamping direction K or the radial direction of the gas turbine (vertical in FIG. 3) is about 90° ; the groove depth direction and the clamping direction are thus essentially perpendicular to each other. In other words, the groove 11 is arranged laterally in the radially protruding flange 13 of the first component 10.

The angle 13 between the groove depth direction (vertical in FIG. 3) and the screw axis S of the setting screw 40 is about 45°.

In the embodiment of FIGS. 1, 2, the articulated section 33, which is rotatably mounted in the groove 11, is fixed in place in a direction parallel to the screw axis S of the setting screw 40 and to the clamping direction K away from the top side of the first component 10 (vertically upward in FIG. 1) in a form-fitting manner by means of the groove flanks 11A, which converge toward the groove edge. In the embodiment of FIGS. 3, 4, the articulated section 33, which is rotatably mounted in the groove 11, is also fixed in place in a direction parallel to the screw axis S of the setting screw 40 and in a direction parallel to the clamping direction K away from the top side of the first component 10 (toward the top left or vertically upward in FIG. 3) in a form-fitting manner by means of the upper groove flank 11A in FIG. 3. Correspondingly, in both embodiments, the groove 11 has an undercut or a stop, on which the articulated section 33 is supported, in respectively at least one direction away from the top side of the first component.

Although, in the preceding description, exemplary embodiments were explained, it is noted that a large number of modifications are possible. Moreover, it is noted that the exemplary embodiments are merely examples, which shall in no way limit the protective scope, the applications, and the design. Instead, the preceding description provides the person skilled in the art with a guideline for implementing at least one exemplary embodiment, with it being possible to make diverse changes, in particular in regard to the function and arrangement of the described components, without departing from the protective scope, as ensues from the claims and combinations of features equivalent to these.

### LIST OF REFERENCE NUMBERS

10 first component

11 groove

11A groove flank

11B groove base

12 recess

13 flange

20 second component

21 flange

30 rocker

31 first arm

32 second arm

33 articulated section

34 stop

40 setting screw

41 nut

D axis of rotation

K clamping direction

S screw axis

α angle between the groove depth direction and the clamping direction/radial direction

β angle between the groove depth direction and the screw axis

1. A component arrangement for a gas turbine, having:
a first wall segment (10) of a gas turbine duct casing;
a second wall segment (20) of a gas turbine duct casing with a flange (21), connected to it, which is beveled and which partially overlaps the first wall segment (10);
a rocker (30) with an articulated section (33), which is rotatably mounted in a groove (11) on the first component, which, in a cross section perpendicular to the groove longitudinal direction, has two groove flanks (11A) that lie opposite each other in the groove longitudinal direction, a groove base (11B) connecting these groove flanks, and a groove edge that lies opposite the groove base in the groove depth direction; and
a setting screw (40);
wherein the flange (21) of the second wall segment (20) is clamped between the first wall segment (10) and an arm (31) of the rocker, which is tightened against the flange (21) by the setting screw (40).

2. The component arrangement for a gas turbine according to claim 1, wherein the setting screw (40) is supported on the first wall segment (10) on a surface of the first wall segment that is on the rocker side and, , faces away from a gas duct defined by the component.

3. The component arrangement for a gas turbine according to claim 1, wherein the setting screw (40) is arranged on a side, lying opposite to the arm (31), of an axis of rotation (D) of the articulated section (33), which is rotatably mounted in the groove, and/or forces apart the first wall segment (10) and the rocker (30).

4. The component arrangement for a gas turbine according to claim 1, wherein the setting screw is secured in a recess (12) in the first wall segment (10) in the longitudinal direction of the groove in a form-fitting manner.

5. The component arrangement for a gas turbine according to claim 1, wherein the setting screw is screwed with a thread in the rocker (30) or with a nut (41), which is supported on the rocker (40).

6. The component arrangement for a gas turbine according to claim 1, wherein the rocker (40) is secured on the first wall segment (10) at one end or both ends in the groove longitudinal direction in a form-fitting manner.

7. The component arrangement for a gas turbine according to claim 6, wherein the rocker (30) has at least one stop (34) in the groove longitudinal direction, which engages under the groove (11) in a form-fitting manner.

8. The component arrangement for a gas turbine according to claim 1, wherein the groove (11) is open at one end or at both ends in the groove longitudinal direction.

9. The component arrangement for a gas turbine according to claim 1, wherein a groove cross section converges in the groove depth direction toward the groove edge.

10. The component arrangement for a gas turbine according to claim 1, wherein an angle (a) between the groove depth direction and a clamping direction (K) of the clamping of the flange between the first wall segment (10) and the first arm of the rocker is at most 15° or at least 45°, in particular at least 75°.

11. The component arrangement for a gas turbine according to claim 1, wherein an angle ((3) between the groove depth direction and a screw axis (S) of the setting screw is at most 15° or at least 30°, in particular at least 45°.

12. The component arrangement for a gas turbine according to claim 1, wherein the groove (11) is arranged in a protruding flange (13) of the first wall segment (10).

13. The component arrangement for a gas turbine according to claim 1, wherein the articulated section (33) of the rocker (30) is mounted in the groove (11) on the first wall segment (10), and the setting screw (40) is screwed in so as to tighten the arm (31) of the rocker against the flange (21).

14. The component arrangement for a gas turbine according to claim 1, wherein the component arrangement is configured and arranged for use in a gas turbine.

15. The component arrangement for a gas turbine according to claim 1, wherein the wall segment (10) is a fairing or panel, of a gas turbine duct casing, with a turbine center frame between a first turbine and a second turbine, and the second wall segment (20), is a panel or fairing of the gas turbine duct casing.
